(19) United States
(12) Patent Application Publication
(10) Pub. No.: US 2011/0158412 A1
(43) Pub. Date: Jun. 30, 2011

(54) INFORMATION DISCLOSURE APPARATUS

(75) Inventor: Masaharu Kako, Osaka (JP)

(73) Assignee: FUJITSU LIMITED, Kawasaki-shi (JP)

(21) Appl. No.: 13/040,613

(22) Filed: Mar. 4, 2011

Related U.S. Application Data
(63) Continuation of application No. PCT/JP2008/066111, filed on Sep. 5, 2008.

(51) Int. Cl. H04L 9/08; H04L 9/00

(52) U.S. Cl. 380/282; 380/277

(57) ABSTRACT

An information tray creation apparatus generates a pair of an encryption key and a decoding key, encrypts disclosure information using the encryption key, and generates encrypted disclosure information. Next, the information tray creation apparatus encrypts a decoding key using a public key of a disclosure destination, and generates decoding key information. The information tray creation apparatus adds a pair of the disclosure destination and the decoding key information to disclosure destination information in an information tray as one record. The information tray creation apparatus then adds pairs of disclosure destinations and decoding key information to the disclosure destination information in the information tray for all information destinations.

### CROSS-REFERENCE TO RELATED APPLICATION

This application is a continuation of International Application No. PCT/JP2008/066111, filed on Sep. 5, 2008, the entire contents of which are incorporated herein by reference.

### FIELD

The embodiments discussed herein are directed to an information disclosure apparatus.

### BACKGROUND

There is conventionally known a technique for determining whether to disclose confidential information by performing access authentication so as to prevent leakage of confidential information when making public the confidential information disclosed only to a specific person, as disclosed in Japanese Laid-open Patent Publication No. 2004-38270.

For example, a viewer requests in advance a server to register him/her as an access-permitted person subjected to access authentication. When receiving the registration request of the access permission, the server determines whether to register the viewer and performs an access permission registration.

Thereafter, if detecting access, the server performs an access authentication processing for determining whether the viewer registered as the access-permitted person (registrant) accesses the server. As a result, if a viewer A is the access-permitted registrant, the viewer is able to access confidential information.

As another example, if the viewer A is not registered as the access-permitted registrant, then the viewer A is not permitted to access the server and unable to refer to disclosed information by a disclosing person S, as exemplified in FIG. 22 and FIG. 23.

The conventional access authentication technique stated above has the following problems. The technique is on the premise of registration of the access permission in the server in advance. Due to this, if the viewer is not registered as the access-permitted registrant in advance and confidential information cannot be disclosed to the viewer, the disclosing person is unable to disclose the confidential information to an arbitrary disclosure destination, that is, the viewer.

Furthermore, there is proposed a method of permitting anonymous access or a method of disclosing confidential information to suit convenience of an individual viewer so that a disclosing person can disclose confidential information to an arbitrary disclosure destination. However, these methods disadvantageously make disclosure operation complicated and cause the confidential information to be disclosed to an unintended viewer. As a result, it is disadvantageously impossible to appropriately prevent information leakage.

### SUMMARY

According to an aspect of an embodiment of the invention, an information disclosure apparatus includes a disclosure information encryption unit that encrypts disclosure information using an encryption key, and generates encrypted disclosure information; a decoding key encryption unit that encrypts a decoding key using a public key set for every disclosure destination, and generates decoding key information; and an information tray mounting unit that mounts the encrypted disclosure information generated by the disclosure information encryption unit and the decoding key information generated by the decoding key encryption unit in an information tray.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 illustrates a system configuration of a confidential information disclosure system according to a first embodiment of the present invention;

FIG. 2 is a block diagram illustrating a configuration of an information tray creation apparatus according to the first embodiment;

FIG. 3 illustrates an exemplary configuration of an information tray according to the first embodiment;

FIG. 4 is a block diagram illustrating a configuration of a disclosure information reference apparatus according to the first embodiment;

FIG. 5 is a block diagram illustrating a configuration of a file server according to the first embodiment;

FIG. 6 is a flowchart illustrating an operation for an information tray creation processing performed by the information tray creation apparatus according to the first embodiment;

FIG. 7 is a flowchart illustrating an operation for a decoding processing performed by the disclosure information reference apparatus according to the first embodiment;

FIG. 8 illustrates a system configuration of a confidential information disclosure system according to a second embodiment of the present invention;

FIG. 9 is a flowchart illustrating an operation for an information tray creation processing performed by an information tray creation apparatus according to the second embodiment;

FIG. 10 illustrates a system configuration of a confidential information disclosure system according to a third embodiment of the present invention;

FIG. 11 is a flowchart illustrating an operation for an information tray creation processing performed by an information tray creation apparatus according to the third embodiment;

FIG. 12 illustrates a system configuration of a confidential information disclosure system according to a fourth embodiment of the present invention;

FIG. 13 is a flowchart illustrating an operation for an information tray creation processing performed by an information tray creation apparatus according to the fourth embodiment;

FIG. 14 illustrates an exemplary configuration of an information tray according to the fourth embodiment;

FIG. 15 is a flowchart illustrating an operation for an information tray creation processing performed by an information tray creation apparatus according to a fifth embodiment of the present invention;

FIG. 16 illustrates an exemplary configuration of a confidentiality-degree status list;

FIG. 17 illustrates an exemplary configuration of a confidentiality-degree condition list;

FIG. 18 is a flowchart illustrating an operation for a confidentiality guarantee alarm processing performed by a file server according to the fifth embodiment;

FIG. 19 illustrates an exemplary configuration of an information tray based on common key cipher system according to a sixth embodiment of the present invention;

FIG. 20 is a flowchart illustrating an operation for an information tray creation processing performed by an information tray creation apparatus according to the sixth embodiment;

FIG. 21 is a flowchart illustrating an operation for a decoding processing performed by a disclosure information reference apparatus according to the sixth embodiment;

FIG. 22 illustrates a conventional technique; and FIG. 23 illustrates the conventional technique.

### DESCRIPTION OF EMBODIMENTS

Preferred embodiments of the present invention will be explained with reference to accompanying drawings.

### [a] First Embodiment

A configuration and a processing flow of an information tray creation apparatus according to a first embodiment of the present invention will be described in sequence, and the effect of the first embodiment will be described at the end. In this embodiment, an instance of disclosing confidential information created by a disclosing person via a file server will be described.

Configuration of Information Tray Creation Apparatus

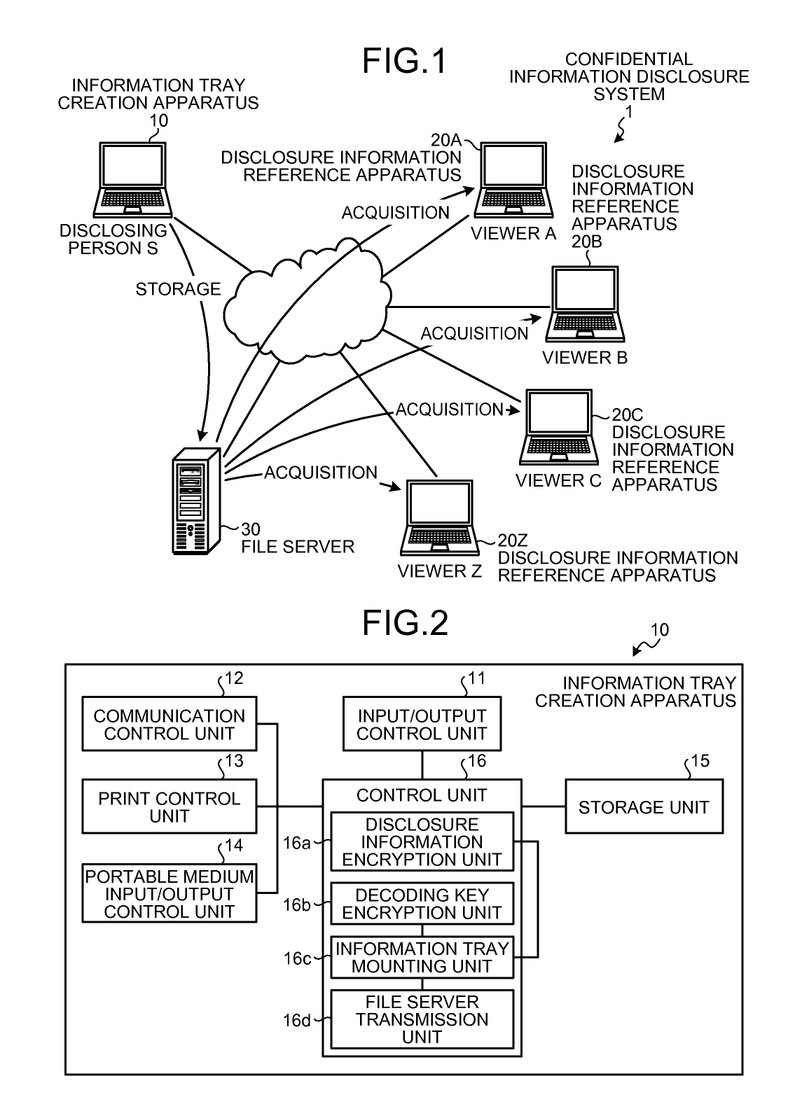

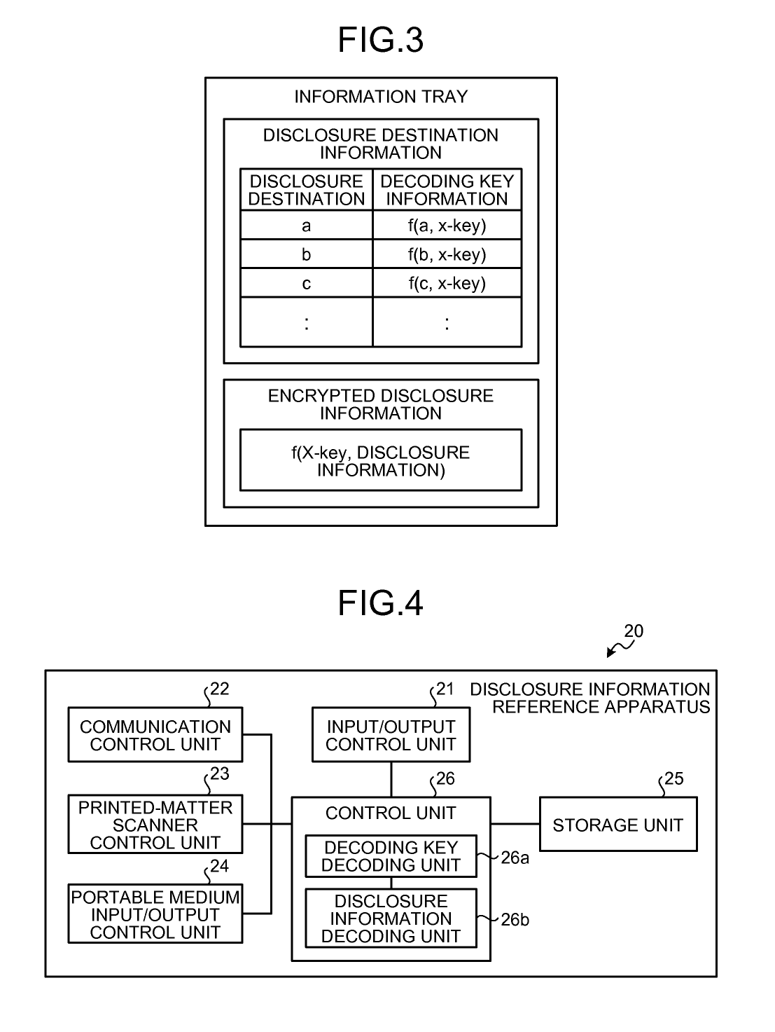

Referring to FIGS. 1 to 3, a system configuration of an information tray creation apparatus 10 according to the first embodiment will be described. FIG. 1 illustrates a system configuration of a confidential information disclosure system 1 according to the first embodiment. FIG. 2 is a block diagram of the information tray creation apparatus 10 according to the first embodiment. FIG. 3 illustrates an exemplary configuration of an information tray.

Referring to FIG. 1, the confidential information disclosure system including the information tray creation apparatus 10 according to the first embodiment will first be described. As illustrated in FIG. 1, the confidential information disclosure system 1 includes the information tray creation apparatus 10, a plurality of disclosure information reference apparatuses 20A, 20B, 20C, and 20Z, (often generically “information reference apparatuses 20”) and a file server 30. The constituent elements of the confidential information disclosure system 1 are mutually connected via a network.

The information tray creation apparatus 10 receives an operation instruction from a disclosing person S, creates an information tray, and transmits the created information tray to the file server 30 to store the information tray in the file server 30.

The file server 30 stores the information tray created by the information tray creation apparatus 10 and makes the information tray public to the third party. Each disclosure information reference apparatus 20 requests and acquires the information tray from the file server 30, decodes the acquired information tray, and displays the decoded information tray to a viewer.

The configuration of the information tray creation apparatus 10 will now be described with reference to FIG. 2. As illustrated in FIG. 2, the information tray creation apparatus 10 includes an input/output control unit 11, a communication control unit 12, a print control unit 13, a portable medium input/output control unit 14, a storage unit 15, and a control unit 16. Processings performed by the constituent elements of the information tray creation apparatus 10 will be described below.

The input/output control unit 11 controls an input device (a keyboard or a mouse) for inputting an instruction from an operator (a disclosing person) and the like and an output device (a monitor or a display) for displaying a result for the instruction. Specifically, the input/output control unit 11 inputs “disclosure information” and “disclosure destination” designated by the disclosing person.

The communication control unit 12 controls transmission or reception of information to or from the other apparatuses via the network. Specifically, the communication control unit 12 transmits the created information tray to the file server 30.

The print control unit 13 exerts control to print information on a print medium such as paper. The portable medium input/output control unit 14 controls input or output of information to or from a portable medium such as a floppy (registered trademark).

The storage unit 15 stores data and programs necessary for various processings performed by the control unit 16, particularly stores public keys, encryption programs and the like.

The control unit 16 includes an internal memory for storing programs and required data specifying various processing procedures or the like and executes various processings according to the programs and data. The control unit 16 particularly includes a disclosure information encryption unit 16a, a decoding key encryption unit 16b, an information tray mounting unit 16c, and a file server transmission unit 16d. The processings will be described below while referring mainly to an instance in which the disclosure destination is “a”, the private key is “A”, and the public key is “a”.

The disclosure information encryption unit 16a encrypts disclosure information using an encryption key and generates encrypted disclosure information. Specifically, the disclosure information encryption unit 16a generates a pair of an encryption key “X-key” and a decoding key “x-key”, encrypts the disclosure information using the encryption key, and generates “f(X-key, disclosure information)”. The disclosure information encryption unit 16a notifies the information tray mounting unit 16c of “f(X-key, disclosure information)” as the encrypted disclosure information.

The decoding key encryption unit 16b encrypts the decoding key using a public key set for every disclosure information reference apparatus 20 and generates decoding key information. Specifically, the decoding key encryption unit 16b encrypts the decoding key “x-key” using the public key “a” of the disclosure destination and generates “f(a, x-key)”. The decoding key encryption unit 16b notifies the information tray mounting unit 16c of the public key “a” and “decoding key information=f(a, x-key)”.

The information tray mounting unit 16c mounts the generated encrypted disclosure information and the generated decoding key information in the information tray. Specifically, when receiving “f(X-key, disclosure information)” from the disclosure information encryption unit 16a, the information tray mounting unit 16c describes “f(X-key, disclosure information)” as the encrypted disclosure information in the information tray.

Furthermore, when receiving the public key “a” and “decoding key information=f(a, x-key)” from the decoding key encryption unit 16b, the information tray mounting unit 16c additionally describes, as one record, a pair of “disclosure destination=a” and “decoding key information=f(a, x-key)” in the disclosure destination information mounted in the information tray.

Thereafter, if performing processings for additionally describing pairs of “disclosure destinations=a, b, c . . . ” and “decoding key information=f (a, x-key), (b, x-key), (c, x-key) . . . ” for all disclosure destinations, respectively in the disclosure destination information mounted in the information tray, the information tray mounting unit 16c notifies the file server transmission unit 16d of a request of transmitting the information tray to the file server 30.

The exemplary configuration of the information tray will be described with reference to FIG. 3. As illustrated in FIG. 3, the information tray mounts therein “disclosure destinations” and “decoding key information”, which are made to correspond to one another, as the disclosure destination information as well as “encrypted disclosure information” as the encrypted disclosure information.

“X-key” is the encryption key for encrypting disclosure information and “x-key” is the decoding key for decoding the encrypted disclosure information to make the disclosure information readable. As stated above, the “encrypted disclosure information” is obtained by encrypting the disclosure information using the encryption key “X-key” based on a public key cipher system “f”. The “decoding key information” is information obtained by encrypting the decoding key “x-key” using the “public key” of each of the disclosure destinations (viewers).

The file server transmission unit 16d transmits the information tray to the file server 30 to store the information tray in the file server 30. Specifically, the file server transmission unit 16d transmits the information tray to the file server 30 when receiving the request of transmitting the information tray to the file server 30 from the information tray mounting unit 16c.

Configuration of Disclosure Information Reference Apparatus

Referring to FIG. 4, a configuration of the disclosure information reference apparatus 20 according to the first embodiment will be described. FIG. 4 is a block diagram illustrating the configuration of the disclosure information reference apparatus 20 according to the first embodiment will be described. As illustrated in FIG. 4, the disclosure information reference apparatus 20 includes an input/output control unit 21, a communication control unit 22, a printed-matter scanner control unit 23, a portable medium input/output control unit 24, a storage unit 25, and a control unit 26. Processings performed by the respective constituent elements of the disclosure information reference apparatus 20 will be described.

The input/output control unit 21 controls an input device (a keyboard or a mouse) for inputting instruction from an operator and the like and an output device (a monitor or a display) for displaying a result for the instruction. Specifically, the input/output control unit 21 controls the output device to display decoded disclosure information or to output a notification to the effect that decoding of the disclosure information fails.

The communication control unit 22 controls transmission or reception of information to or from the other apparatuses via the network. Specifically, the communication control unit 22 transmits the request of transmitting the information tray to the file server 30 and receives the requested information tray.

The printed-matter scanner control unit 23 controls a reader (such as a scanner) for reading information printed on a print medium such as paper. The portable medium input/output control unit 24 controls input or output of information to or from a portable medium such as a floppy (registered trademark).

The storage unit 25 stores data and programs necessary for various processings performed by the control unit 26, particularly stores public keys, decoding programs and the like.

The control unit 26 includes an internal memory for storing programs and required data specifying various processing procedures or the like and executes various processing according to the programs and data. The control unit 26 particularly includes a decoding key decoding unit 26a and a disclosure information decoding unit 26b.

The decoding key decoding unit 26a decodes the decoding key information using a private key and acquires a decoding key. Specifically, the decoding key decoding unit 26a searches a record in which the disclosure destination in the disclosure destination information acquired from the file server 30 is matched with the public key “a” of the viewer. As a result, if such a record is not present, the decoding key decoding unit 26a causes the output device (not illustrated) to display a notification to the effect of decoding failure and finishes the processing.

If the matched record is present, the decoding key decoding unit 26a extracts the decoding key information “f(a, x-key)” corresponding to the disclosure destination information in the matched record. The decoding key decoding unit 26a decodes the extracted “f(a, x-key)” using the private key “A” of the viewer, acquires the decoding key “x-key”, and notifies the disclosure information decoding unit 26b of the decoding key “x-key”.

The disclosure information decoding unit 26b decodes the encrypted disclosure information using the acquired decoding key and acquires the disclosure information. Specifically, the disclosure information decoding unit 26b extracts the encrypted disclosure information “f(X-key, disclosure information)” from the information tray.

The disclosure information decoding unit 26b decodes the extracted encrypted disclosure information “f(X-key, disclosure information)” using the decoding key “x-key” and acquires the disclosure information. The disclosure information reference apparatus 20 then displays the acquired disclosure information on the output device (not illustrated).

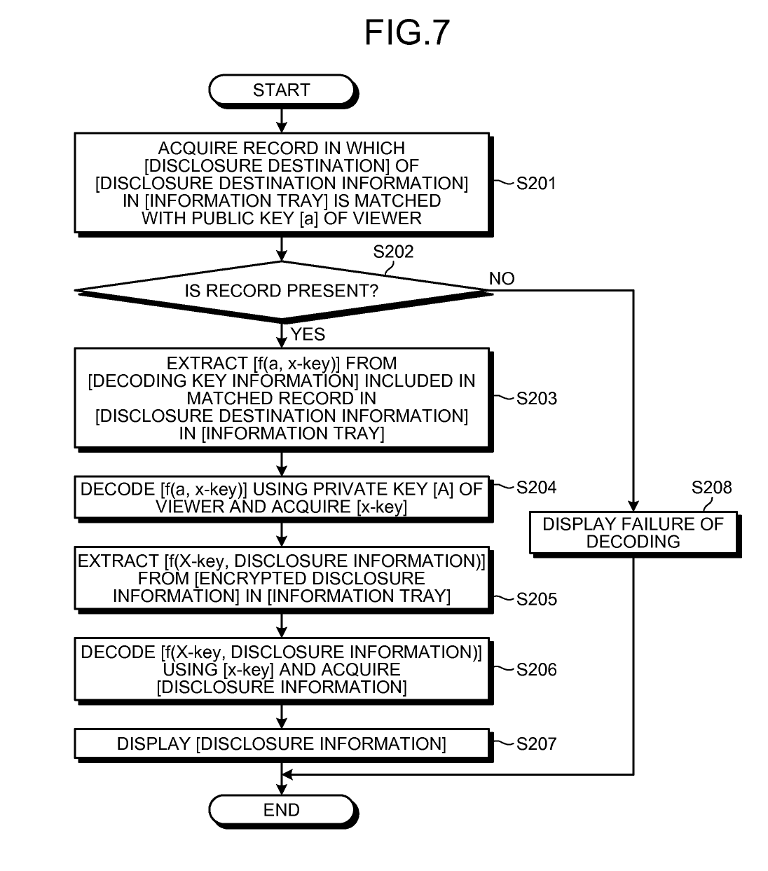

In FIG. 1, for example, the disclosure information reference apparatus 20A of the viewer A acquires the information tray created by the disclosing person S from the file server 30 at discretion of the viewer A, decodes the “disclosure information” by performing a decoding processing (to be described later in detail with reference to FIG. 7) using the private key “A” and the public key “a” of the viewer A, and displays a content of the “disclosure information” on a display device (not illustrated).

On the other hand, the disclosure information reference apparatus 20Z of a viewer Z acquires the information tray created by the disclosing person S from the file server 30 at discretion of the viewer Z, performs a decoding processing (to be described later in detail with reference to FIG. 7) using a private key “Z” and a public key “z” of the viewer Z, and displays the content of the “disclosure information” on the display device.

Configuration of File Server

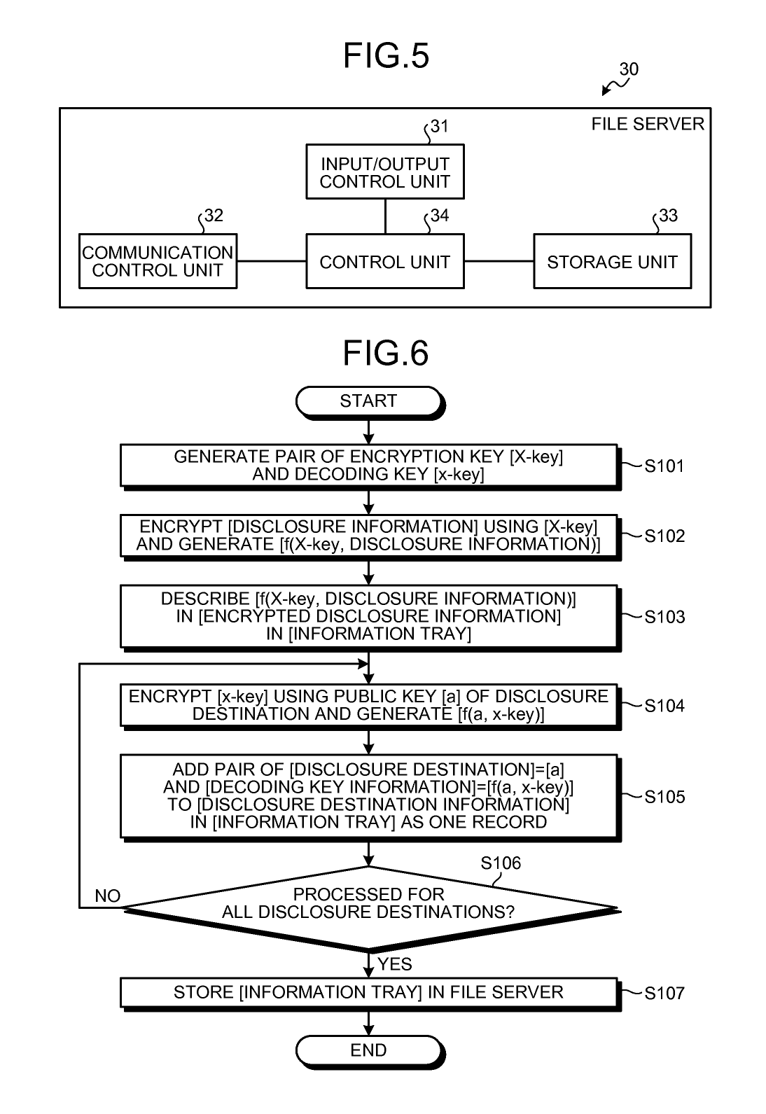

Referring to FIG. 5, a configuration of the file server 30 according to the first embodiment will be described. FIG. 5 is a block diagram illustrating the configuration of the file server 30 according to the first embodiment. As illustrated in FIG. 5, the file server 30 includes an input/output control unit 31, a communication control unit 32, a storage unit 33, and a control unit 34. Processings performed by the respective constituent elements of the file server 30 will be described.

The input/output control unit 31 controls an input device (a keyboard or a mouse) for inputting an instruction from an operator and the like and an output device (a monitor or a display) for displaying a result for the instruction. The communication control unit 32 control transmission or reception of information to or from other apparatuses via the network. Specifically, the communication control unit 32 receives the information tray from the information tray creation apparatus 10. The communication control unit 32 also receives the request of transmitting the information tray from one of the disclosure information reference apparatuses 20 and transmits the requested information tray to the disclosure information reference apparatus 20.

The storage unit 33 stores data and programs necessary for various processings performed by the control unit 34, particularly stores the information tray received from the information tray creation apparatus 10 and the like. The control unit 34 includes an internal memory storing programs and required data specifying various processing procedures or the like and executes various processings according to the programs and data.

Processings Performed by Information Tray Creation Apparatus

Referring to FIG. 6, processings performed by the information tray creation apparatus 10 according to the first embodiment will next be described. FIG. 6 is a flowchart illustrating an operation for the processings performed by the information tray creation apparatus 10 according to the first embodiment. The processings will be described below while referring mainly to an example of the instance in which the disclosure destination is “a”, the private key is “A”, and the public key is “a”.

As illustrated in FIG. 6, the information tray creation apparatus 10 creates a pair of the encryption key “X-key” and the decoding key “x-key” (step S101), encrypts disclosure information using the encryption key, and generates “f(X-key, disclosure information)” (step S102). The information tray creation apparatus 10 describes “f(X-key, disclosure information)” as the encrypted disclosure information in the information tray (step S103).

Next, the information tray creation apparatus 10 encrypts the decoding key “x-key” using the public key “a” of the disclosure destination, and generates “f(a, x-key)” (step S104). The information tray creation apparatus 10 additionally describes, as one record, a pair of “disclosure destination=a” and “decoding key information=f(a, x-key)” as the disclosure destination information mounted in the information tray (step S105).

Thereafter, the information tray creation apparatus 10 determines whether the information tray creation apparatus 10 has performed processings for additionally describing pairs of “disclosure destinations=a, b, c . . . ” and “decoding key information=f (a, x-key), (b, x-key), (c, x-key) . . . ” for all disclosure destinations, respectively (step S106). If the information tray creation apparatus 10 has not performed the processings for all the disclosure destinations (step S106, “No”), the information tray creation apparatus 10 repeats the processings from the step S104 to the step S106.

Moreover, if the information tray creation apparatus 10 has performed the processings for all the disclosure destinations (step S106, “Yes”), the information tray creation apparatus 10 transmits the information tray to the file server 30 to store the information tray in the file server 30 (step S107).

Processings performed by Disclosure Information

### Reference Apparatus

Referring to FIG. 7, processings performed by each disclosure information reference apparatus 20 according to the first embodiment will next be described. FIG. 7 is a flowchart illustrating an operation for a decoding processing performed by the disclosure information reference apparatus 20 according to the first embodiment.

As illustrated in FIG. 7, the disclosure information reference apparatus 20 searches a record in which the disclosure destination in the disclosure destination information acquired from the file server 30 is matched with the public key “a” of the viewer (step S201). As a result, if such a record is not present (step S201, “No”), the disclosure information reference apparatus 20 displays a decoding failure (step S208) and finishes the processing.

If the matched record is present (step S202, “Yes”), the disclosure information reference apparatus 20 extracts “f(a, x-key)” from the decoding key information of the matched record corresponding to the disclosure destination information in the information tray (step S203). The disclosure information reference apparatus 20 decodes the extracted “f(a, x-key)” using the private key “A” of the viewer and acquires the decoding key “x-key” (step S204).

The disclosure information reference apparatus 20 extracts “f(X-key, disclosure information)” from the encrypted disclosure information in the information tray (step S205), decodes the extracted “f(X-key, disclosure information)” using the decoding key “x-key” and acquires the disclosure information (step S206). Thereafter, the disclosure information reference apparatus 20 displays the acquired disclosure information (step S207).

### Effect of First Embodiment

As described above, the information tray creation apparatus 10 encrypts the disclosure information using the encryption key, generates the encrypted disclosure information, encrypts the decoding key using the public key set for every disclosure destination, and generates the decoding key information. The information tray creation apparatus 10 mounts the generated encrypted disclosure information and the generated decoding key information in the information tray. Thus, the information tray creation apparatus 10 encrypts the decoding key using the public key of each viewer to which the disclosing person is to disclose the information, and encrypts the disclosure information itself using the common encryption key. It is thereby possible to disclose confidential information to an arbitrary apparatus while appropriately preventing leakage of the disclosure information.

Furthermore, according to the first embodiment, each disclosure information reference apparatus 20 decodes the decoding key information encrypted using the public key of the disclosure information reference apparatus 20 using the private key and acquires the decoding key. In addition, the disclosure information reference apparatus 20 decodes the encrypted disclosure information encrypted using the encryption key using the decoding key and acquires the disclosure information. Due to this, the disclosure information reference apparatus 20 can acquire the decoding key using only the private key of the disclosure information reference apparatus 20 without being subjected to access authentication by the file server 30 or the like. As a result, it is possible to easily acquire the disclosure information while preventing disclosure of the information to viewers to which the information is not to be disclosed.

### [b] Second Embodiment

In the first embodiment, the instance of disclosing the information tray in the file server 30 has been described. However, the embodiments are is not limited to this instance but the information tray can be transmitted by mail.

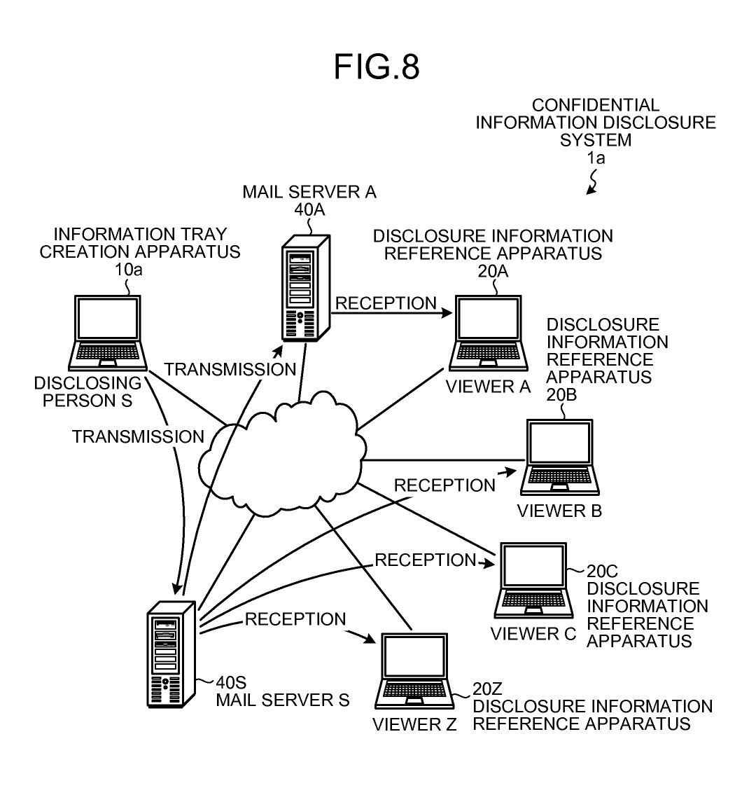

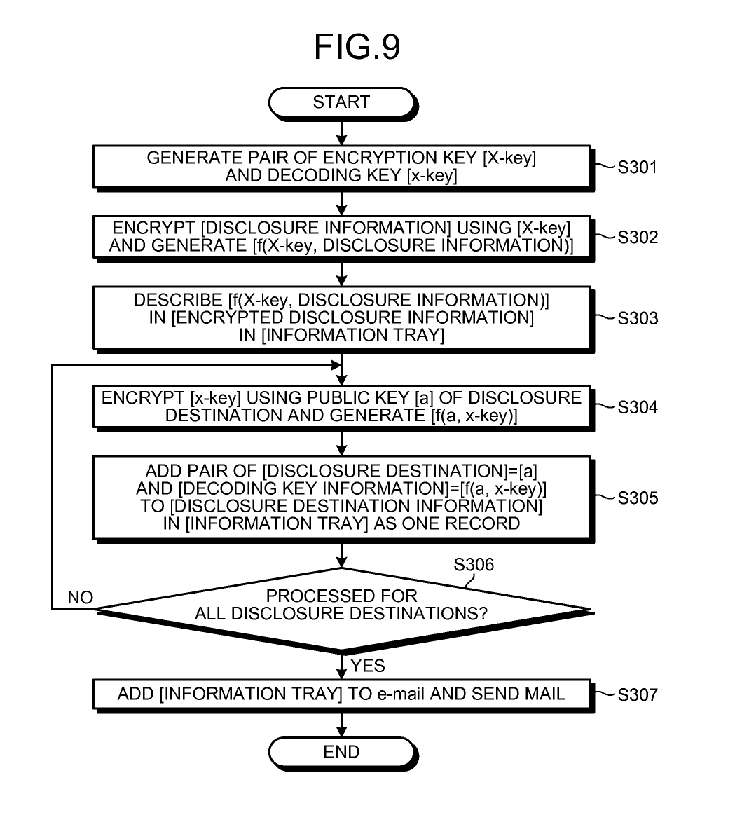

Therefore, a configuration of and processings performed by a confidential information disclosure system 1a according to a second embodiment of the present invention will be described with reference to FIGS. 8 and 9, while referring to an instance in which an information tray creation apparatus 10a adds an information tray to e-mail and transmits the e-mail to a disclosure information reference apparatus 20 via a mail server 40. FIG. 8 illustrates a system configuration of the confidential information disclosure system 1a according to the second embodiment. FIG. 9 is a flowchart illustrating an operation for an information tray creation processing performed by the information tray creation apparatus 10a according to the second embodiment.

The system configuration of the confidential information disclosure system 1a according to the second embodiment will first be described. As illustrated in FIG. 8, the confidential information disclosure system 1a differs from the confidential information disclosure system 1 illustrated in FIG. 1 in that the confidential information disclosure system 1a newly includes mail servers 40 in place of the file server 30.

One of the mail servers 40 receives mail to which the information tray created by the information tray creation apparatus 10a is added, and transmits the received mail to one of the disclosure information reference apparatuses 20 or another mail server 40.

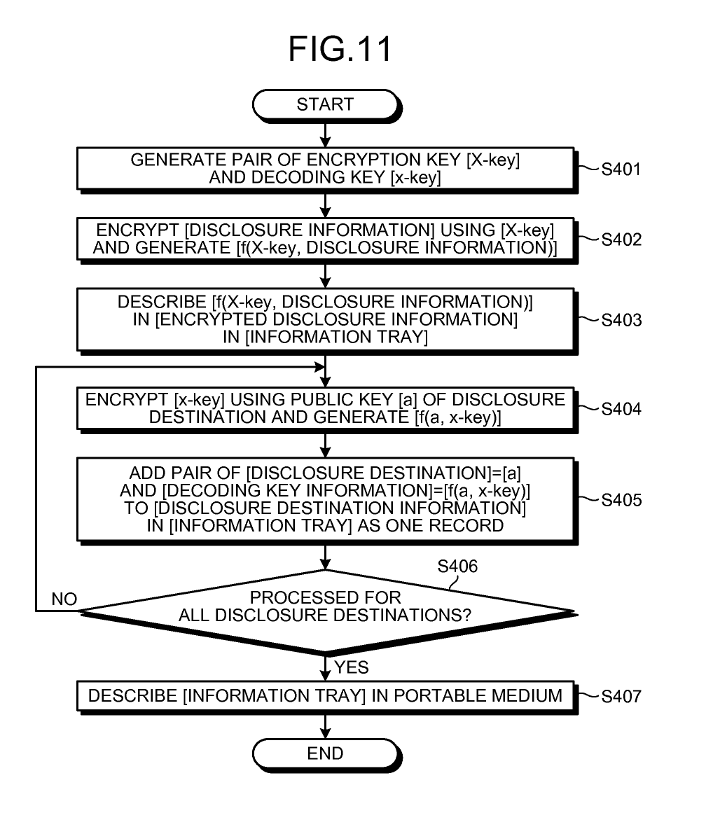

In an example of FIG. 8, the information tray creation apparatus 10a designates disclosure information and disclosure destinations A, B, and C, creates the information tray (as described later in detail with reference to FIG. 11), and transmits the mail to which the information tray is added to a mail server S to which the disclosing person S subscribes. The mail server 40S relays the mail to a mail server 40A to which a viewer A subscribes.

The disclosure information reference apparatus 20A of the viewer A acquires the information tray created by the disclosing person S from the mail server A to which the viewer A subscribes at discretion of the viewer A. In addition, the disclosure information reference apparatus 20A decodes “disclosure information” by performing the decoding processing (see FIG. 7) using the private key A and the public key a of the disclosure information reference apparatus 20A, and displays a content of the “disclosure information” on the display device.

On the other hand, the disclosure information reference apparatus 20Z of the viewer Z acquires the information tray created by the disclosing person S from the mail server S to which the viewer Z subscribes at discretion of the viewer Z. In addition, the disclosure information reference apparatus 20Z performs the decoding processing (see FIG. 7) using the private key Z and the public key z of the disclosure information reference apparatus 20Z, and displays “decoding failure” on the display device.

An information tray creation processing performed by the information tray creation apparatus 10a according to the second embodiment will next be described. The information tray creation processing performed by the information tray creation apparatus 10a according to the second embodiment differs from that according to the first embodiment illustrated in FIG. 6 in newly performing processing procedures of adding the information tray to e-mail and transmitting the e-mail.

That is, as illustrated in FIG. 9, the information tray creation apparatus 10a performs processing procedures for adding pairs of “disclosure destinations=a, b, c . . . ” and “decoding key information=f (a, x-key) , (b, x-key), (c, x-key) . . . ” for all the disclosure destinations, respectively (steps S304 to S306) similarly to FIG. 6. Thereafter, the information tray creation apparatus 10a adds the information tray to the e-mail and transmits the e-mail to the mail server 40S (step S307).

In this way, in the second embodiment described above, the information tray creation apparatus 10a exerts control to transmit the information tray to each disclosure destination by the mail. It is, therefore, possible to notify each viewer of the information tray in a mail service.

### [c] Third Embodiment

In the first embodiment, the instance of disclosing the information tray in the file server has been described. However, the embodiments are not limited to this instance but the information tray can be distributed using a portable medium.

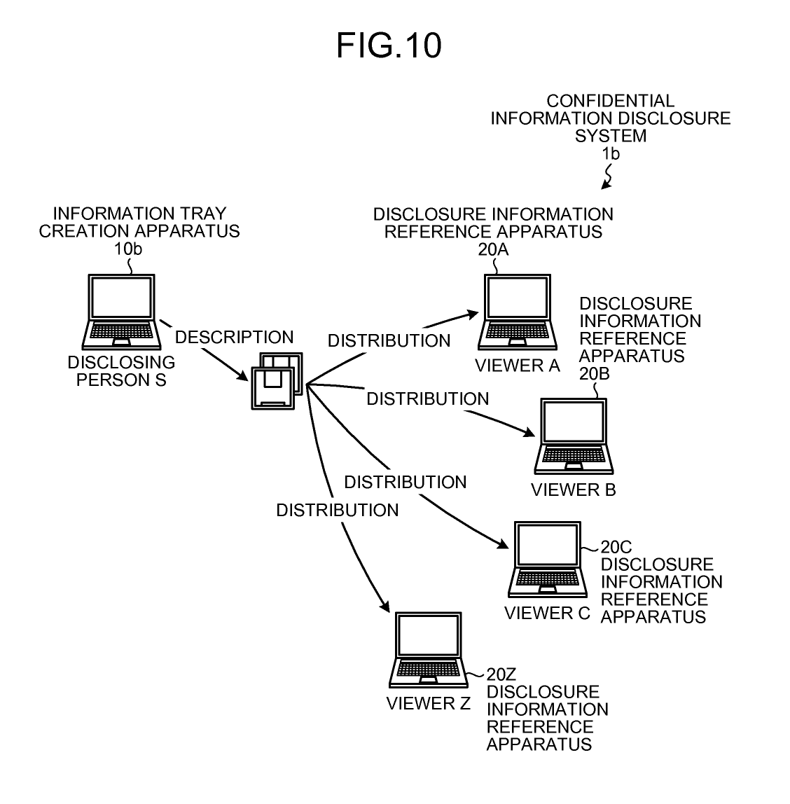

Therefore, in a third embodiment, a configuration of and processings performed by a confidential information disclosure system 1b according to the third embodiment of the present invention will be described with reference to FIGS. 10 and 11, while referring to an instance in which an information tray creation apparatus 10b describes an information tray in a portable medium. FIG. 10 illustrates a system configuration of the confidential information disclosure system 1b according to the third embodiment. FIG. 11 is a flowchart illustrating an operation for an information tray creation processing performed by the information tray creation apparatus 10b according to the third embodiment.

The system configuration of the confidential information disclosure system 1b according to the third embodiment will first be described. As illustrated in FIG. 10, the confidential information disclosure system 1b differs from the confidential information disclosure system 1 illustrated in FIG. 1 in that a portable medium is directly distributed without using the file server 30.

In an example of FIG. 10, the information tray creation apparatus 10b designates disclosure information and disclosure destinations A, B, and C, creates the information tray (as described later in detail with reference to FIG. 11), stores the information tray in the portable medium, and distributes the portable medium to each viewer.

The disclosure information reference apparatus 20A of the viewer A acquires the information tray from the portable medium distributed from the disclosing person S at discretion of the viewer A. In addition, the disclosure information reference apparatus 20A decodes “disclosure information” by performing the decoding processing (see FIG. 7) using the private key A and the public key a of the disclosure information reference apparatus 20A, and displays a content of the “disclosure information” on the display device.

On the other hand, the disclosure information reference apparatus 20Z of the viewer Z acquires the information tray from the portable medium distributed from the disclosing person S at discretion of the viewer Z. In addition, the disclosure information reference apparatus 20Z performs the decoding processing (see FIG. 7) using the private key Z and the public key z of the disclosure information reference apparatus 20Z and displays “decoding failure” on the display device.

An information tray creation processing performed by the information tray creation apparatus 10b according to the third embodiment will next be described. The information tray creation processing performed by the information tray creation apparatus 10b according to the third embodiment differs from that illustrated in FIG. 6 according to the first embodiment in newly performing a processing procedure of describing the information tray in the portable medium.

That is, as illustrated in FIG. 11, the information tray creation apparatus 10b performs processing procedures for adding pairs of “disclosure destinations=a, b, c . . . ” and “decoding key information=f (a, x-key) , (b, x-key), (c, x-key) . . . ” for all the disclosure destinations, respectively (steps S404 to S406) similarly to FIG. 6. Thereafter, the information tray creation apparatus 10b describes the information tray in the portable medium (step S407).

In this way, in the third embodiment, the information tray creation apparatus 10b exerts control to store the information tray in the portable medium. It is, therefore, possible to distribute the information tray to each disclosure destination using the portable medium.

### [d] Fourth Embodiment

In the first embodiment, the instance of disclosing the information tray on the file server has been described. However, the embodiments are not limited to this instance but the information tray can be printed on a print medium.

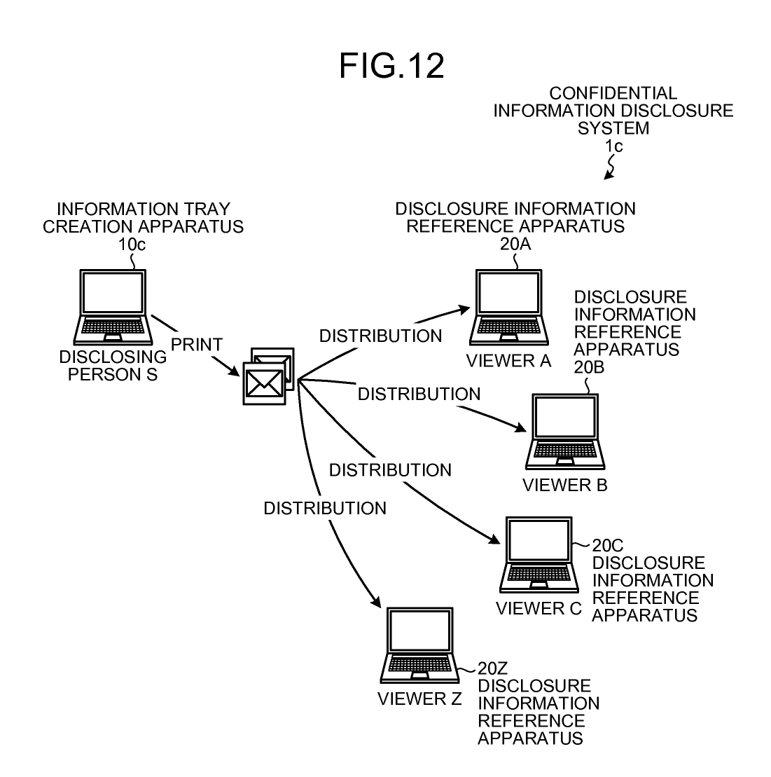

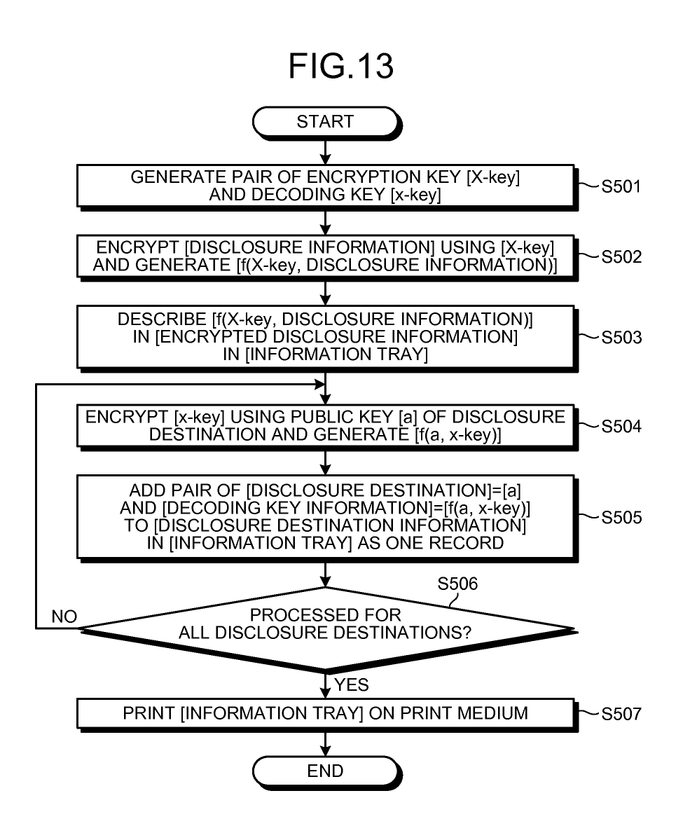

Therefore, in a fourth embodiment, a configuration of and processings performed by a confidential information disclosure system 1c according to the fourth embodiment of the present invention will be described with reference to FIGS. 12 and 13 while referring to an instance in which an information tray creation apparatus 10c prints the information tray on the print medium. FIG. 12 illustrates a system configuration of the confidential information disclosure system 1c according to the fourth embodiment. FIG. 13 is a flowchart illustrating an operation for an information tray creation processing performed by an information tray creation apparatus 10c according to the fourth embodiment.

The system configuration of the confidential information disclosure system 1c according to the fourth embodiment will first be described. As illustrated in FIG. 12, the confidential information disclosure system 1cdiffers from the confidential information disclosure system 1 illustrated in FIG. 1 in that a print medium is directly distributed without using the file server 30.

In an example of FIG. 12, the information tray creation apparatus 10c designates disclosure information and disclosure destinations A, B, and C, creates the information tray (as described later in detail with reference to FIG. 13), prints the information tray on the print medium, and distributes the print medium to each viewer.

The disclosure information reference apparatus 20A of the viewer A acquires the information tray from the print medium distributed from the disclosing person S at discretion of the viewer A. In addition, the disclosure information reference apparatus 20A decodes “disclosure information” by performing the decoding processing (see FIG. 7) using the private key A and the public key a of the disclosure information reference apparatus 20A, and displays a content of the “disclosure information” on the display device.

On the other hand, the disclosure information reference apparatus 20Z of the viewer Z acquires the information tray from the print medium distributed from the disclosing person S at discretion of the viewer Z. In addition, the disclosure information reference apparatus 20Z performs the decoding processing (see FIG. 7) using the private key Z and the public key z of the disclosure information reference apparatus 20Z and displays “decoding failure” on the display device.

An information tray creation processing performed by the information tray creation apparatus 10c according to the fourth embodiment will next be described. The information tray creation processing performed by the information tray creation apparatus 10c according to the fourth embodiment differs from that illustrated in FIG. 6 according to the first embodiment in newly performing a processing procedure of printing the information tray on the print medium.

That is, as illustrated in FIG. 13, the information tray creation apparatus 10c performs processing procedures for adding pairs of “disclosure destinations 32 a, b, c . . . ” and “decoding key information=f (a, x-key) , (b, x-key), (c, x-key) . . . ” for all the disclosure destinations, respectively (steps S504 to S506) similarly to FIG. 6. Thereafter, the information tray creation apparatus 10c prints the information tray on the print medium (step S507).

In this way, in the fourth embodiment, the information tray creation apparatus 10c exerts control to print the information tray on the print medium. It is, therefore, possible to distribute the information tray to each viewer using the print medium.

### [e] Fifth Embodiment

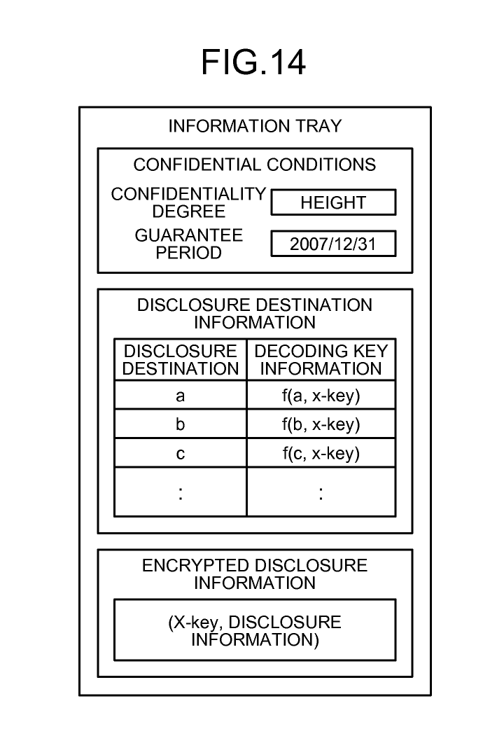

Meanwhile, according to the embodiments of the present invention, confidential conditions can be set according to disclosure information described in the information tray. Therefore, in a fifth embodiment, a configuration of and processings performed by a confidential information disclosure system 1d according to a fifth embodiment of the present invention will be described with reference to FIGS. 14 to 18 while referring to an instance in which an information tray creation apparatus 10d sets confidential conditions set by a disclosing person to an information tray, and abandons the information tray if the confidential conditions cannot be guaranteed.

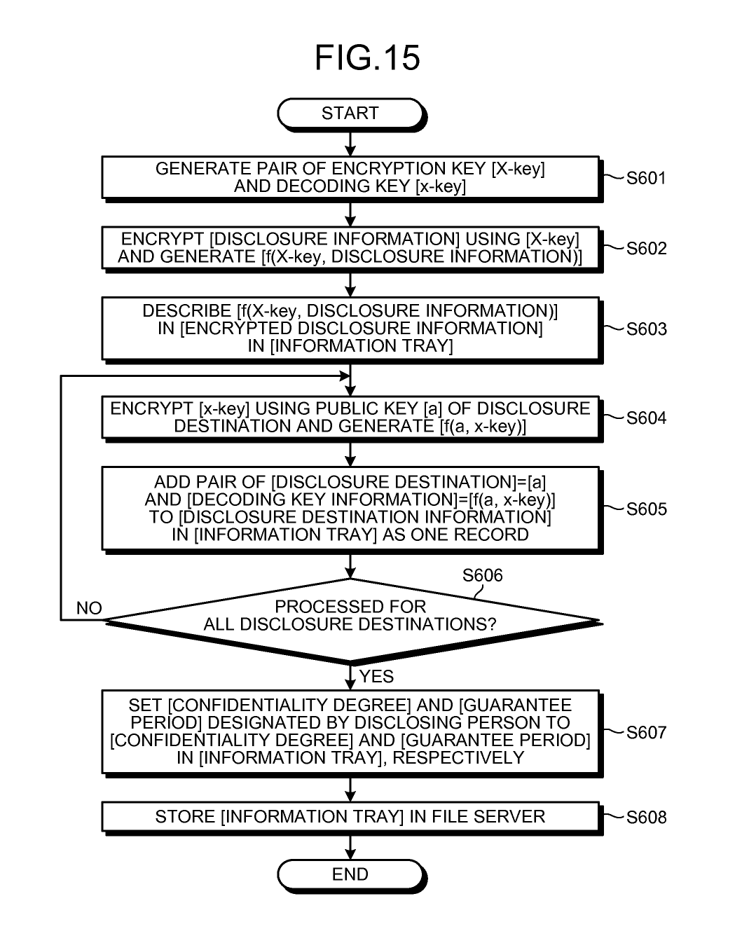

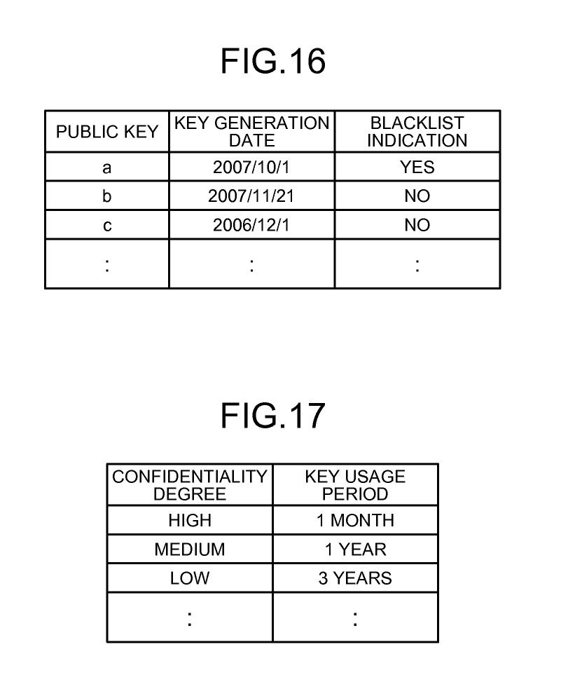

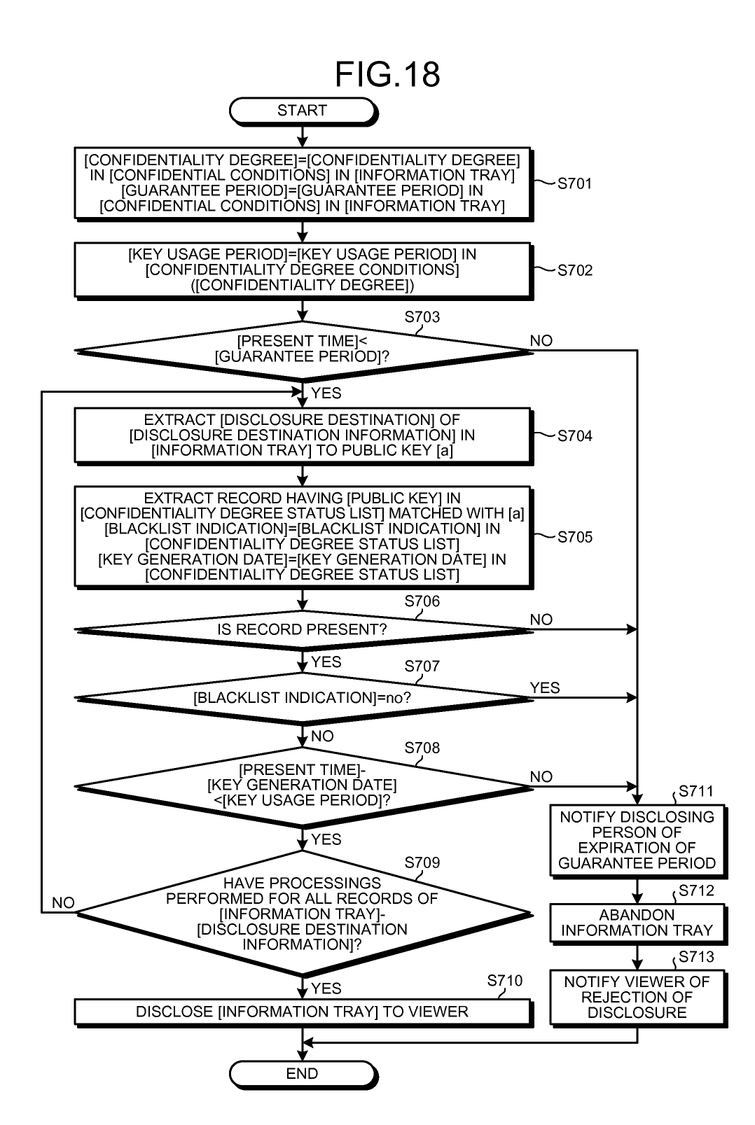

FIG. 14 illustrates an exemplary configuration of the information tray. FIG. 15 is a flowchart illustrating an operation for an information tray creation processing performed by the information tray creation apparatus 10d according to the fifth embodiment. FIG. 16 illustrates an exemplary configuration of a confidentiality-degree status list. FIG. 17 illustrates an exemplary configuration of a confidentiality-degree condition list. FIG. 18 is a flowchart illustrating an operation for a confidentiality guarantee alarm processing performed by a file server according to the fifth embodiment.

The exemplary configuration of the information tray created by the information tray creation apparatus 10d according to the fifth embodiment will first be described with reference to FIG. 14. As illustrated in FIG. 14, the information tray creation apparatus 10d differs from that “confidentiality degree” indicating a degree of confidentiality of the disclosure information and “guarantee period” indicating a disclosure period of the disclosure information are newly added as confidential conditions indicating conditions for disclosing the information tray.

The “confidentiality degree” is made to correspond to a key usage period by a confidentiality-degree condition list to be described later. The “confidentiality degree” indicates the degree of confidentiality of the disclosure information and a period in which the disclosure information can be decoded using the decoding key.

An information tray creation processing performed by the information tray creation apparatus 10d according to the fifth embodiment will next be described. The information tray creation apparatus 10d according to the fifth embodiment differs from that according to the first embodiment illustrated in FIG. 6 in mounting confidential conditions (confidentiality degree and guarantee period) in the information tray.

That is, as illustrated in FIG. 15, the information tray creation apparatus 10d performs processing procedures for adding pairs of “disclosure destinations=a, b, c . . . ” and “decoding key information=f (a, x-key) , (b, x-key), (c, x-key) . . . ” for all the disclosure destinations, respectively similarly to FIG. 6 (steps S604 to S606).

Thereafter, the information tray creation apparatus 10d according to the fifth embodiment sets a confidentiality degree (for example, “height”) and a guarantee period (for example, “2007/12/31”) designated by the disclosing person to items “confidentiality degree” and “guarantee period” of the information tray, respectively (step S607). The information tray creation apparatus 10d transmits the created information tray to a file server 30a (not illustrated) to store the information tray in the file server 30a (step S608).

Next, a confidentiality-degree status list and a confidentiality-degree condition list held by the file server 30a according to the fifth embodiment will be described. As exemplarily illustrated in FIG. 16, in the confidentiality-degree status list, “key generation date” indicating a data of generating the key and “blacklist indication” indicating whether a viewer can refer to the disclosure information are stored for every public key while being made to correspond to each other.

Furthermore, as exemplarily illustrated in FIG. 17, in the confidentiality-degree condition list, “confidentiality degree” indicating the degree of the confidentiality of the disclosure information and “key usage period” indicating a period for which the key can be used from the key generation date are stored while being made to correspond to each other.

The confidentiality guarantee alarm processing performed by the file server 30a that holds the confidentiality-degree status list will next be described with reference to FIG. 18.

As illustrated in FIG. 18, the file server 30a acquires the “confidentiality degree” and “guarantee period” as the confidential conditions in the information tray (step S701), and acquires the “key usage period” corresponding to the acquired “confidentiality degree” from the confidentiality-degree condition list (step S702).

The file server 30a determines whether the “guarantee period” expires at present time at which the file server 30a acquires the “confidentiality degree”, “guarantee period”, and “key usage period” (step S703). As a result, if the “guarantee period” expires at the present time (step S703, “No”), then the file server 30a notifies the disclosing person of expiration of the guarantee period (step S710), abandons the information tray (step S711), and notifies the viewer of rejection of disclosure (step S712).

On the other hand, if the “guarantee period” does not expire at the present time (step S703, “Yes”), then the file server 30a extracts the “disclosure destination” of the disclosure information in the information tray (step S704). The file server 30a searches a record (blacklist indication, key generation date) matched with the “disclosure destination” to which the “public key” in the confidentiality-degree status list is extracted (step S705).

As a result of the search, if the matched record is present (step S706, “Yes”), the file server 30a determines whether or not the blacklist indication of the record is “no” (step S707). As a result, if the blacklist indication is not “no” (step S707, “No”), the file server 30a determines whether or not passing time from the “key generation date” to the “present time” exceeds the key usage period (step S708).

As a result, if the passing time from the “key generation date” to the “present time” does not exceed the key usage period (step S708, “Yes”), the file server 30a determines whether the processing procedures from the step S704 to the step S708 have been performed for all the disclosure destination information in the information tray (step S709).

As a result of the determination, if the processing procedures have not been performed for all the disclosure destination information (step S709, “No”), the file server 30a repeatedly performs the processing procedures from the step S704 to the step S708 until performing the processing procedures for all the disclosure destinations. If the processing procedures have not been performed for all the disclosure destination information (step S709, “Yes”), the file server 30a discloses the information tray to the viewers.

On the other hand, if the matched record is not present (step S706, “No”), the blacklist indication is “no” (step S707, “Yes”), and the passing time from the “key generation date” to the “present time” exceeds the key usage period (step S708, “No”), then the file server 30a notifies the disclosing person of the expiration of the guarantee period (step S710), abandons the information tray (step S711), and notifies the viewers of rejection of disclosure (step S712).

If the information tray creation apparatus 10d performs the confidentiality guarantee alarm processing described above but cannot guarantee the confidential conditions, the information tray creation apparatus 10d can abandon the information tray.

In this way, in the fifth embodiment, the encrypted disclosure information and the decoding key information are mounted in the information tray, and the confidential conditions indicating conditions for disclosing the information tray are mounted in the information tray. It is thereby possible for the disclosing person to designate a degree of importance of the disclosure information. As a result, it is possible to prevent leakage of information more appropriately.

Moreover, if the guarantee period indicating the period of disclosing the disclosure information is mounted in the information tray and the guarantee period expires, the information tray creation apparatus 10d abandons the information tray. It is thereby possible to automatically abandon the disclosure information after passage of a predetermined period. As a result, it is possible to prevent the leakage of information more appropriately.

Furthermore, if the guarantee period mounted in the information tray expires, then the information tray creation apparatus 10d abandons the information tray and notifies the disclosing person that the information tray has been abandoned. It is, therefore, possible to make the disclosing person easily grasp the abandonment of the disclosure information.

### [f] Sixth Embodiment

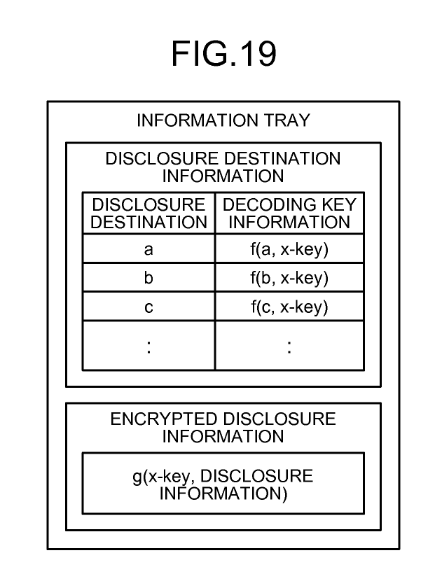

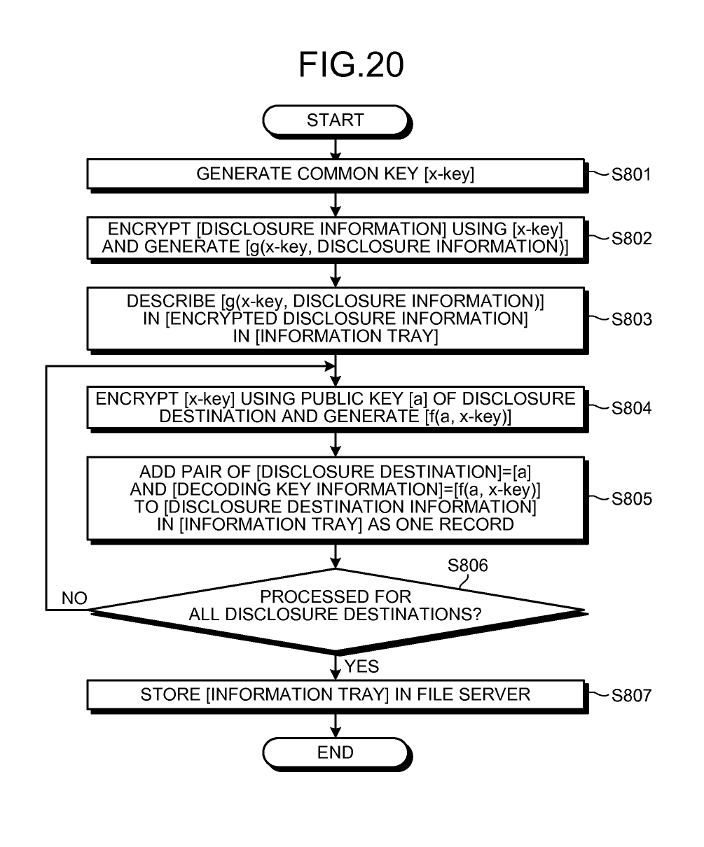

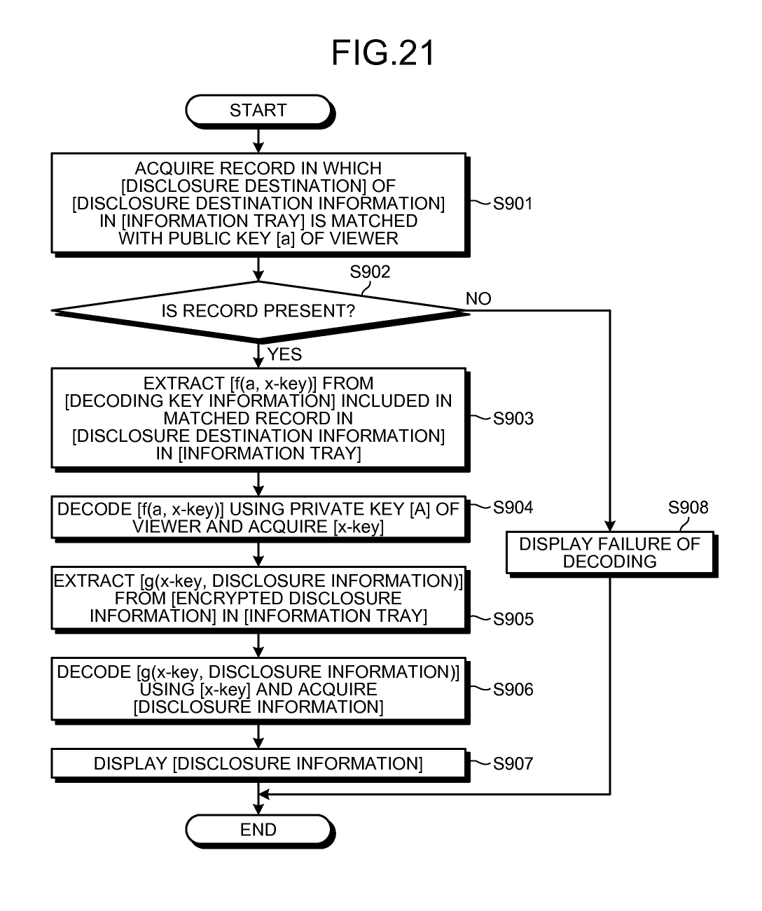

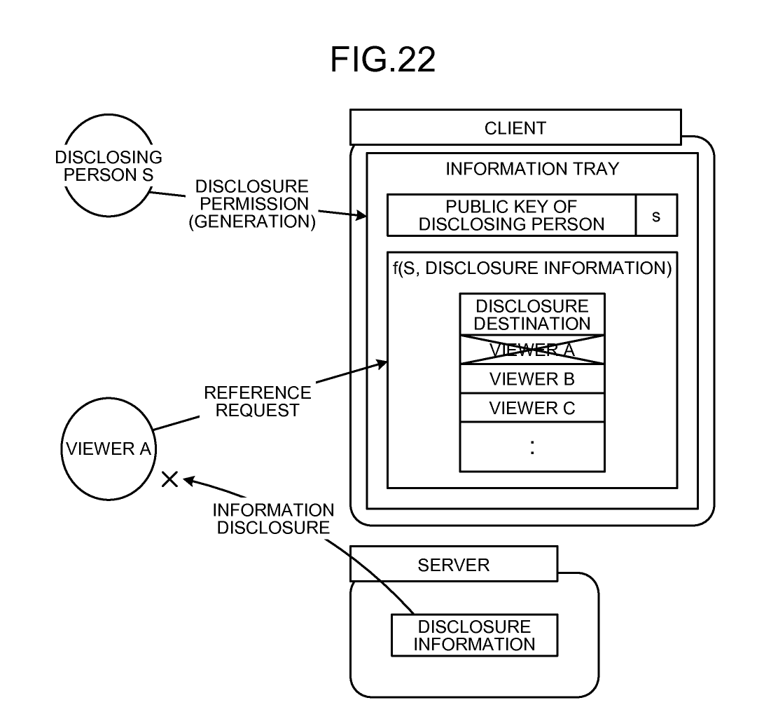

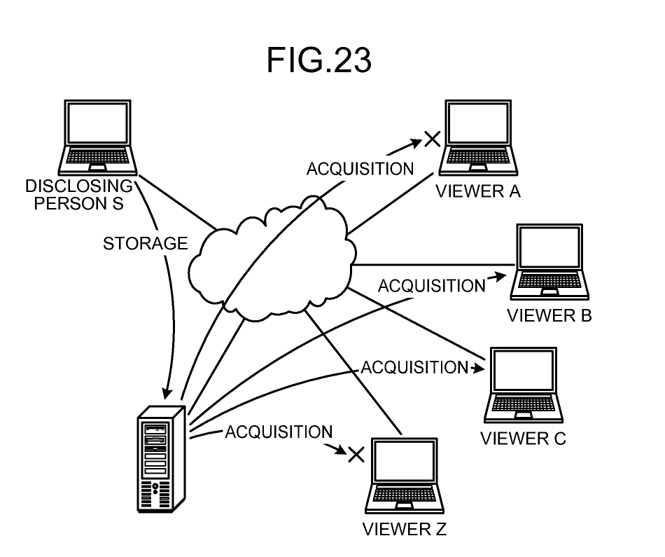

In the embodiments, the disclosure information can be encrypted by common key cipher system. Therefore, processings performed by a confidential information disclosure system le (not illustrated) according to a sixth embodiment of the present invention will be described with reference to FIGS. 19 to 21 while referring to an instance in which an information tray creation apparatus 10e (not illustrated) encrypts disclosure information using a common key. FIG. 19 illustrates an exemplary configuration of an information tray based on the common key cipher system. FIG. 20 is a flowchart illustrating an operation for an information tray creation processing performed by the information tray creation apparatus 10e according to the sixth embodiment. FIG. 21 is a flowchart illustrating an operation for a decoding processing performed by each disclosure information reference apparatus 20a according to the sixth embodiment.

The exemplary configuration of the information tray based on the common key cipher system created by the confidential information disclosure system 1e according to the sixth embodiment will first be described with reference to FIG. 19. As illustrated in FIG. 19, the information tray differs from that illustrated in FIG. 3 in that encrypted disclosure information “g(x-key, disclosure information)” obtained by encrypting the disclosure information using the common key “x-key” is mounted in the information tray. It is to be noted that “x-key” is a common key for encrypting or decoding the “disclosure information”.

Referring to FIG. 20, the information tray creation processing performed by the information tray creation apparatus 10e according to the sixth embodiment will next be described. The information tray creation processing performed by the information tray creation apparatus 10e according to the sixth embodiment differs from that according to the first embodiment illustrated in FIG. 6 in performing processing procedures for encrypting disclosure information using the common key. The processing procedures will be described below while referring mainly to the instance in which the disclosure destination is “a”, the private key is “A”, and the public key is “a”.

As illustrated in FIG. 20, the information tray creation apparatus 10e generates the common key “x-key” (step S801), encrypts the disclosure information using the common key, and generates “g(x-key, disclosure information)” (step S802). The information tray creation apparatus 10e describes “g(x-key, disclosure information)” as the encrypted disclosure information in the information tray (step S803).

Next, the information tray creation apparatus 10eencrypts the common key “x-key” using the public key “a” of the disclosure destination, and generates “f(a,x-key)” (step S804). The information tray creation apparatus 10e adds a pair of “disclosure destination =a” and “decoding key information=f(a, x-key)” as the disclosure destination information to the information tray as one record (step S805).

Thereafter, the information tray creation apparatus 10e determines whether processing procedures for adding pairs of “disclosure destinations=a, b, c . . . ” and “decoding key information=f(a, x-key), (b, x-key), (c, x-key) . . .” have been performed for all the disclosure destinations, respectively (step S806). If the processing procedures have not been performed for all the disclosure destinations (step S806, “No”), the information tray creation apparatus 10e repeatedly performs the processing procedures from the step S804 to the step S806.

If the processing procedures have been performed for all the disclosure destinations (step S806, “Yes”), the information tray creation apparatus 10e transmits the information tray to the file server 30 to store the information tray in the file server 30 (step S807).

Referring to FIG. 21, the decoding processing performed by each disclosure information reference apparatus 20a (not illustrated) according to the sixth embodiment will next be described. The decoding processing performed by the disclosure information reference apparatus 20a according to the sixth embodiment differs from that according to the first embodiment illustrated in FIG. 7 in performing a processing procedure for decoding the disclosure information using the common key.

As illustrated in FIG. 21, the disclosure information reference apparatus 20a extracts “f(a, x-key)” from the decoding key information in the matched record in the disclosure destination information in the information tray (step S903). Thereafter, the disclosure information reference apparatus 20a decodes the extracted “f(a, x-key)” using the private key “A” of the viewer and acquires the common key “x-key” (step S904).

The disclosure information reference apparatus 20a extracts “g(x-key, disclosure information)” from the encrypted disclosure information in the information tray (step S905), decodes the extracted “g(x-key, disclosure information)” using the common key “x-key”, and acquires the disclosure information (step S906). Thereafter, the disclosure information reference apparatus 20a displays the acquired disclosure information (step S907).

### [g] Seventh Embodiment

While the embodiments of the present invention have been described so far, the present invention can be carried out by various different embodiments other than the embodiments stated above. Therefore, other embodiments that can be contained in the present invention will be described as a seventh embodiment of the present invention.

(1) System Configuration and the like

The respective constituent elements of the apparatuses illustrated in the drawings are functionally conceptual and not always physically configured as illustrated in the drawings. That is, specific forms of disintegration or integration of the apparatuses are not limited to those illustrated in the drawings but all of or a part of the apparatuses can be configured to be disintegrated or integrated either functionally or physically in arbitrary units according to various loads, usage situations and the like. For example, the information tray creation apparatus 10 can be integrated with the file server 30. Furthermore, all of or a part of the processing functions performed by the respective apparatuses can be realized by a CPU and a program analyzed and executed by the CPU or realized as hardware based on wired logic.

Moreover, out of the processings described in the embodiments, all of or a part of the processings described to be performed automatically can be performed manually. Alternatively, all of or a part of the processings described to be performed manually can be performed automatically by a well-known method. Besides, the processing procedures, control procedures, specific names, and information including various data and parameters described or illustrated in the specification or the drawings can be arbitrarily changed unless specified otherwise.

(2) Program

The confidential information disclosure method described in the embodiments can be realized by causing a computer such as a personal computer or a workstation to execute a program prepared in advance. This program can be distributed via a network such as the Internet. Further, this program can be executed by being recorded in a computer-readable recording medium such as a hard disk, a flexible disk (FD), a CD-ROM, an MO or a DVD and by causing a computer to read the program from the recording medium.

An apparatus of an embodiment exhibits advantages of disclosing information to an arbitrary apparatus while appropriately preventing information leakage.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information disclosure apparatus comprising:
a disclosure information encryption unit that encrypts disclosure information using an encryption key, and generates encrypted disclosure information;
a decoding key encryption unit that encrypts a decoding key using a public key set for every disclosure destination, and generates decoding key information; and
an information tray mounting unit that mounts the encrypted disclosure information generated by the disclosure information encryption unit and the decoding key information generated by the decoding key encryption unit in an information tray.

2. The information disclosure apparatus according to claim 1, further comprising a mail transmission control unit that controls the information tray to be transmitted to the disclosure destination by mail.

3. The information disclosure apparatus according to claim 1, further comprising a portable medium control unit that controls the information tray to be stored in a portable medium.

4. The information disclosure apparatus according to claim 1, further comprising a print control unit that controls the information tray to be printed on a print medium.

5. The information disclosure apparatus according to claim 1, wherein
the information tray mounting unit mounts the encrypted disclosure information and the decoding key information in the information tray, and mounts a confidential condition indicating a condition for disclosing the information tray in the information tray.

6. The information disclosure apparatus according to claim 5, wherein
the information tray mounting unit mounts a guarantee period indicating a period of disclosing the disclosure information as the confidential condition in the information tray, and
the information disclosure apparatus further comprises an information tray abandonment unit abandoning the information tray if the guarantee period mounted in the information tray by the information tray mounting unit expires.

7. The information disclosure apparatus according to claim 6, wherein
the information tray abandonment unit abandons the information tray and notifies a disclosing person of abandonment of the information tray if the guarantee period mounted in the information tray by the information tray mounting unit expires.

8. An information disclosure method comprising:
encrypting disclosure information using an encryption key to generate encrypted disclosure information;
encrypting a decoding key using a public key set for every disclosure destination to generate decoding key information; and
mounting the generated encrypted disclosure information and the generated decoding key information in an information tray.

9. A computer-readable, non-transitory medium storing an information disclosure program causing a computer to execute a process comprising:
encrypting disclosure information using an encryption key to generate encrypted disclosure information;
encrypting a decoding key using a public key set for every disclosure destination to generate decoding key information; and
mounting the generated encrypted disclosure information and the generated decoding key information in an information tray.
